(19) United States
(12) Patent Application Publication
(10) Pub. No.: US 2022/0091147 A1
(43) Pub. Date: Mar. 24, 2022

(54) LIQUID HANDLING INSTRUMENT AND PIPETTING HEAD FOR AND METHOD OF ASPIRATING AND/OR DISPENSING LIQUIDS

(71) Applicant: Formulatrix, Inc., Bedford, MA (US)

(72) Inventor: Daniel Kurnianto, Bedford, MA (US)

(73) Assignee: Formulatrix, Inc., Bedford, MA (US)

(21) Appl. No.: 17/426,226

(22) PCT Filed: Dec. 31, 2019
(86) PCT No.: PCT/US2019/069090

§ 371 Date: Jul. 28, 2021

Related U.S. Application Data
(60) Provisional application No. 62/797,687, filed on Jan. 28, 2019.

(51) Int. Cl. G01N 35/10; B01L 3/02; B01L 3/00; G01N 35/02; G01N 35/00

(52) U.S. Cl. CPC G01N 35/1074; G01N 35/1011; G01N 35/1016; B01L 3/0237; G01N 2035/0498; G01N 35/028; G01N 35/0099; G01N 2035/00801; B01L 3/545

(57) ABSTRACT

A liquid handling instrument and pipetting head for and method of aspirating and/or dispensing liquids is disclosed. Namely, an automated liquid handling instrument is provided for aspirating and/or dispensing liquids from source media to destination media using at least one pipetting head and by using a positive displacement pipette tip, wherein the positive displacement pipette tip includes a pipette tip and a pipette plunger. A pipetting head of the liquid handling instrument includes an arrangement of plates, threaded rods, motors, timing (or drive) belts, and custom timing pulleys/nuts. The pipetting head further includes an arrangement of pipette plunger clamping mechanisms and pipette tip clamping mechanisms that feature zero-insertion force clamping mechanisms.

### CROSS-REFERENCE TO RELATED APPLICATIONS

The presently disclosed subject matter is related to U.S. Provisional Patent App. No. 62/797,687, entitled “INSTRUMENT FOR AND METHOD OF ASPIRATING AND/OR DISPENSING LIQUIDS,” filed on Jan. 28, 2019; the entire disclosure of which is incorporated herein by reference.

### TECHNICAL FIELD

The presently disclosed subject matter relates generally to liquid handling methods and more particularly to a liquid handling instrument and pipetting head for and method of aspirating and/or dispensing liquids.

### BACKGROUND

Automated liquid handling instruments include robots used to transfer specific quantities of liquids, such as reagents or samples, between designated containers. Liquid handling instruments are useful in a variety of applications including cell biology, genomics, forensics, and drug research. The instruments assist humans with the repetitive task of transferring liquids in a wide range of volumes to improve speed and efficiency of the operations, as well as precision and accuracy of the delivered volumes. The advantages of automating liquid handling processes include increasing throughput and efficiency of operations and eliminating human errors.

In conventional liquid handling instruments, there is typically a sealed interface between the instrument and each of the pipette tips. The sealed interface is usually a compressible rubber O-ring that requires regular maintenance and/or replacement over the lifetime of the instrument. The compressible rubber O-ring also has the disadvantage of having high friction during pipette tip insertion, which ends up requiring (1) a powerful actuator to achieve the required downward force, and (2) a strong/heavy mechanical structure to handle the high friction from multiple O-rings to perform reliable sealing interface for multiple pipette tips (e.g., 96 pipette tips used with a 96-well sample plate). For example, in conventional liquid handling instruments, one pipette tip may require about 100 grams of insertion force and therefore the actuator for that tip must provide about 100 grams of downward force. Therefore, in a multi-channel liquid handling instrument that processes, for example, 96 pipette tips, the actuator must be capable of about 9.5 kilograms of downward force. Accordingly, a powerful actuator is required that has a strong/heavy mechanical support structure that can handle the high force.

### SUMMARY

The present subject matter describes an instrument and method for aspirating and/or dispensing liquids using pipette tips. In one embodiment, a liquid handling instrument may include: an instrument housing with an instrument deck; a pipetting head above the instrument deck; and a removable tray, the instrument deck holding the removable tray.

The removable tray may include handles. The removable tray may hold one or more microplates, and a tip caddy atop the one or more microplates. The removable tray may have a unique identification number adapted for scanning or reading. The unique identification number could include a 2D barcode or a radio-frequency identification tag.

A robotics instrumentation and controller may also be included in the instrument. For example, the robotics instrumentation may be capable of controlling the movement of the pipetting head with respect to the instrument deck, and the controller may be capable of executing program instructions.

The instrument may further include one or multiple positive displacement pipette tips, the pipetting head may be a multi-channel pipetting head integrated with a multi-position stage, for manipulating the one or more positive displacement pipette tips.

The pipetting head may further include: multiple plates arranged in a stack with respect to four threaded roads; one or more motors that drive one or more respective timing belts, the one or more motors supported by the multiple plates; and a top heat mounting plate.

The multiple plates may be substantially rectangular, the four threaded rods may be arranged in substantially rectangular configuration correlating to the four corners of the multiple plates. In one embodiment, the multiple plates may be eight plates arranged in order from bottom to top along the four threaded rods.

The bottom plate may be held fixed at the bottom end of the four threaded rods, the top plate may be held fixed at the top of the four threaded rods, the remaining plates may be arranged between the top and bottom plates and moveable along the four threaded rods.

In one embodiment, the bottom plate may be a pipette tip collet holder plate where the one or more positive displacement pipette tips may be mounted. The instrument may further include one or more pipette tip clamping mechanisms. The one of the one or more motors may be a clamping tip motor, the one or more of the timing belts may be a clamping tip timing belt, the clamping tip motor and the clamping tip timing belt may be adapted to move one or more of the multiple plates away from or toward the bottom plate.

In another embodiment, the one or more positive displacement pipette tips may include: a pipette tip that may have an interface portion and a pipette tip body, the interface portion may have an inner wall and a receptacle, the pipette tip body may have a fluid channel along the length of the pipette tip body, and the fluid channel may have an opening at the distal end of the fluid channel; and a pipette plunger may be positioned along the inside of the pipette tip, the pipette plunger may have a plunger upper portion, a plunger centering portion, and a plunger tip having a distal tip portion, wherein the receptacle may be adapted to receive the plunger centering portion. In one embodiment, the fluid channel may be adapted to receive the distal tip portion of the plunger tip, and the one or more pipette tip clamping mechanisms may be zero-insertion force pipette clamping mechanisms.

In another embodiment, the one or more pipette plunger clamping mechanisms may be provided in a central portion of the pipetting head, and each of the one or more pipette plunger mechanisms may couple to a plunger of each of a respective positive displacement pipette tips.

The instrument may further include a set of zero-insertion force pipette plunger clamping mechanisms. In one embodiment, one of the one or more motors may be used for controlling the set of zero-insertion force pipette plunger mechanisms. Also, one of the one or more motors may be a clamping plunger motor, one of one or more timing belts may be a clamping plunger timing belt, the clamping plunger motor and the clamping plunger timing belt may be adapted to move one or more of the multiple plates away from or toward the bottom plate.

The instrument may further include a pipette plunger. In one embodiment, one of the one or more motors may be used for controlling the pipette plunger. The one or more motors may be a metering plunger motor, the one or more timing belts may be a metering plunger timing belt, the metering plunger motor and the metering plunger timing belt may be adapted to move one or more of the multiple plates away from or toward the bottom plate.

The instrument may further include one or more pipette plunger clamping mechanisms that are zero-insertion force pipette plunger clamping mechanisms. In one embodiment, each of the one or more zero-insertion force pipette plunger clamping mechanisms may include a plunger collet and a pipette plunger lock mechanism, the plunger collet may include a shaft portion and a collet chuck portion for fitting around the plunger upper portion of the pipette plunger. Further, the collet chuck portion may be a segmented band or sleeve for fitting round the plunger upper portion of the pipette plunger.

The present subject matter further describes a method for aspirating and/or dispensing liquids. In one embodiment, the method may include the steps of: providing a liquid handling instrument, the liquid handling instrument including an instrument housing with an instrument deck, a pipetting head above the instrument deck, and a removable tray, the instrument deck holding the removable tray, the pipetting head having an arrangement of one or more positive displacement pipette tips for aspirating and dispensing liquids, wherein the pipetting head includes one or more pipette tip clamping mechanisms and one or more pipette plunger clamping mechanisms, and wherein each of the one or more positive displacement pipette tips include a pipette tip and a corresponding pipette plunger; clamping by the one or more pipette plunger clamping mechanisms the one or more pipette plungers; clamping by the one or more pipette tip clamping mechanisms the one or more pipette tips; and performing an aspirating and/or dispensing operation using the pipette head.

### BRIEF DESCRIPTION OF DRAWINGS

Having thus described the presently disclosed subject matter in general terms, reference will now be made to the accompanying drawings, which are not necessarily drawn to scale, and wherein:

FIG. 1 through FIG. 5 illustrate various perspective views of the presently disclosed multi-channel liquid handling instrument including a pipetting head including an arrangement of positive displacement pipette tips for aspirating and/or dispensing liquids;

FIG. 6, FIG. 7, and FIG. 8 illustrate various perspective views of the presently disclosed pipetting head including an arrangement of positive displacement pipette tips for aspirating and/or dispensing liquids;

FIG. 9, FIG. 10, FIG. 11, FIG. 12, FIG. 13, and FIG. 14 illustrate a front view, a back view, a side vies, another side view, a top view, and a bottom view, respectively, of the presently disclosed pipetting head including an arrangement of positive displacement pipette tips for aspirating and/or dispensing liquids;

FIG. 15 illustrates a cross-sectional view of the presently disclosed pipetting head including an arrangement of positive displacement pipette tips for aspirating and/or dispensing liquids;

FIG. 16A and FIG. 16B illustrate perspective views of an example of the positive displacement pipette and the pipette plunger of the presently disclosed pipetting head;

FIG. 17 illustrates a cross-sectional view of an example of the positive displacement pipette and the pipette plunger shown in FIG. 16A and FIG. 16B;

FIG. 18 illustrates a cross-sectional view of the upper portion of the presently disclosed positive displacement pipette tip;

FIG. 19A and FIG. 19B illustrate a side view and a cross-sectional view, respectively, of the pipette tip of the positive displacement pipette tip;

FIG. 20 illustrates a closeup side view of the distal tip portion of the pipette plunger with respect to the distal tip portion of the pipette tip;

FIG. 21 illustrates perspective views of an example of a pipette tip collet for use with the positive displacement pipette tip;

FIG. 22 illustrates a side view of an example of a pipette tip clamping mechanism of the presently disclosed pipetting head;

FIG. 23A and FIG. 23B illustrate a side view and a cross-sectional view, respectively, of an example of a plunger collet for use with the positive displacement pipette tip;

FIG. 24A illustrates a perspective view of the collect chuck portion of the plunger collet shown in FIG. 23A and FIG. 23B;

FIG. 24B illustrates a cross-sectional view of the pipette plunger with respect to the plunger collet shown in FIG. 23A and FIG. 23B;

FIG. 25A and FIG. 25B show an example of a pipette plunger clamping mechanism and a process of clamping a pipette plunger of the presently disclosed pipetting head; and

FIG. 26 illustrates a flow diagram of an example of a method of using the presently disclosed pipetting head including an arrangement of positive displacement pipette tips for aspirating and/or dispensing liquids.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a liquid handling instrument and pipetting head for and method of aspirating and/or dispensing liquids. For example, an automated liquid handling instrument is provided for aspirating and/or dispensing liquids from source media to destination media using at least one pipetting head and by using a positive displacement pipette tip, wherein the positive displacement pipette tip includes a pipette tip and a pipette plunger.

In some embodiments, the presently disclosed automated liquid handling instrument is a multi-channel liquid handling instrument for aspirating and/or dispensing liquids. In one example, the multi-channel liquid handling instrument is an 8-channel liquid handling instrument for manipulating 8 pipette tips in relation to, for example, an 8-well sample plate. In another example, the multi-channel liquid handling instrument is a 96-channel liquid handling instrument for manipulating 96 pipette tips in relation to, for example, a 96-well sample plate.

In some embodiments, the presently disclosed automated liquid handling instrument is a zero-insertion force system that provides a mechanism for inserting a positive displacement pipette tip using zero-insertion force because it requires no sealed interface between the instrument and the pipette tip. For example, the automated liquid handling instrument provides (1) one or more zero-insertion force pipette tip clamping mechanisms, and (2) one or more zero-insertion force pipette plunger clamping mechanisms. Further, each of the clamping mechanisms provide a reliable, zero-insertion force, air-tight seal that requires substantially no regular maintenance and/or replacement and thereby ensures a robust pipetting system.

In some embodiments, the presently disclosed automated liquid handling instrument includes certain features for guarding against contamination. For example, conventional liquid handling instruments typically have a shared air column between all of the pipette tip interfaces, which can be a common source of contamination that can carry over to the next workflow. By contrast, the presently disclosed automated liquid handling instrument does not include a shared air column between pipette tips and is therefore absent this possible source of contamination.

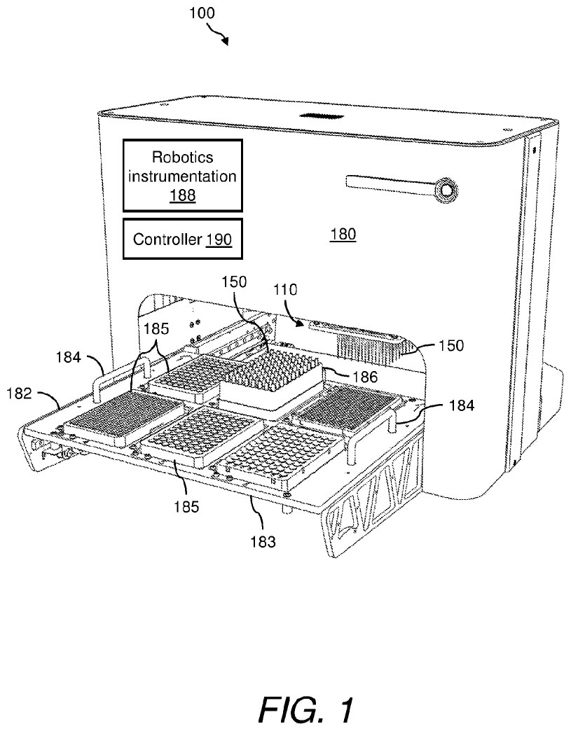

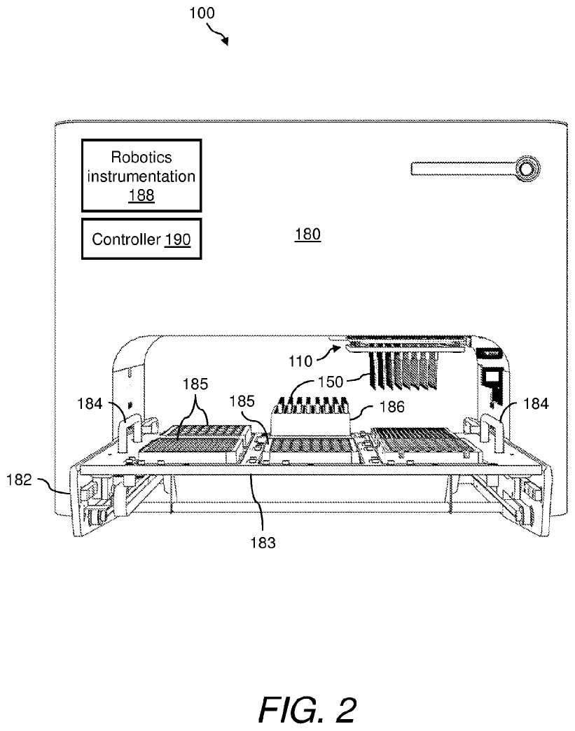

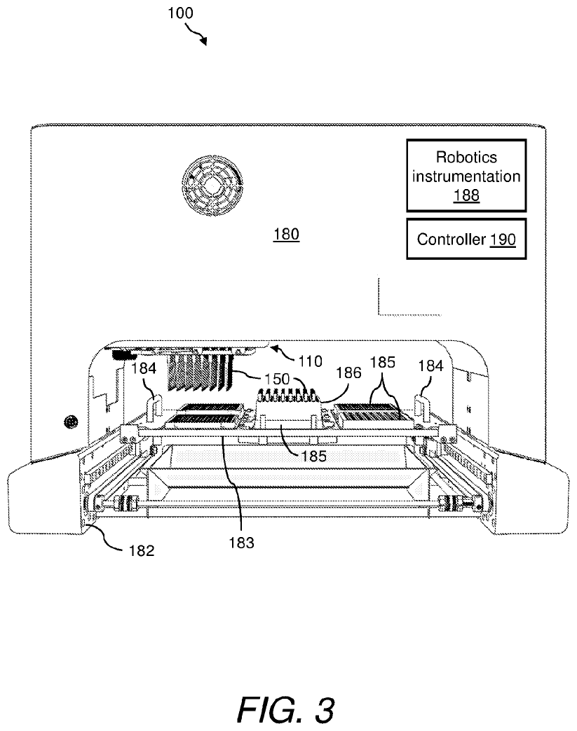

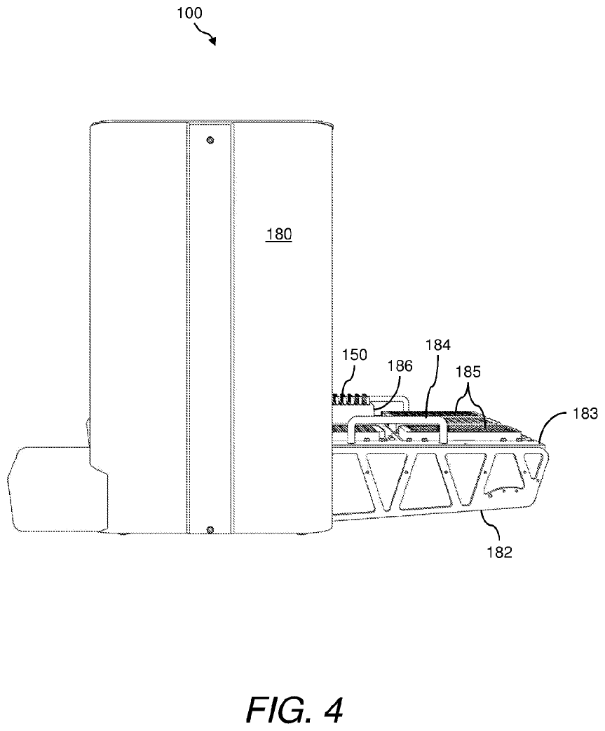

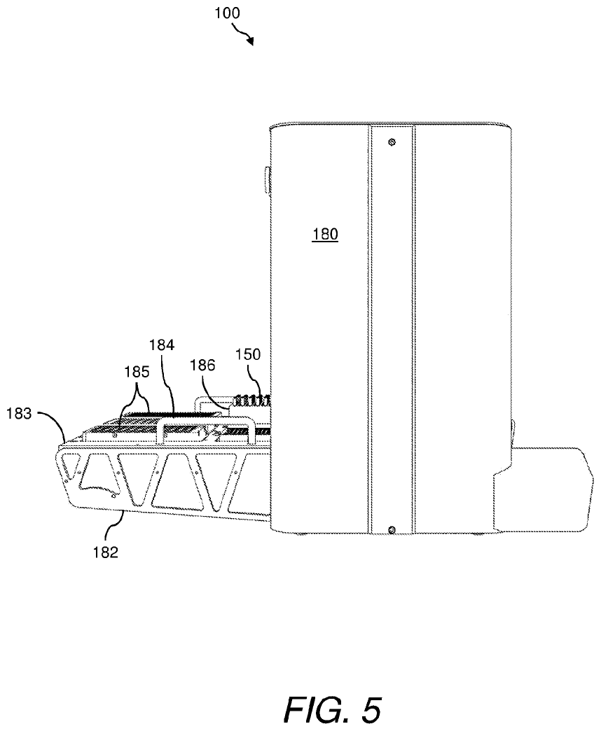

Referring now to FIG. 1 through FIG. 5 are various perspective views of the presently disclosed multi-channel liquid handling instrument 100 including a pipetting head 110 including an arrangement of positive displacement pipette tips for aspirating and/or dispensing liquids. For example, FIG. 1 shows a perspective view, FIG. 2 shows a front view, FIG. 3 shows a back view, FIG. 4 shows one side view, and FIG. 5 shows the opposite side view of the presently disclosed multi-channel liquid handling instrument 100.

The presently disclosed multi-channel liquid handling instrument 100 may be a robotics-based automated liquid handling instrument. The multi-channel liquid handling instrument 100 may include, for example, an instrument housing 180 and an instrument deck 182. The instrument deck 182 may be, for example, two rails, one on each side. The multi-channel liquid handling instrument 100 and the instrument deck 182 is designed to hold removable trays. For example, a removable tray 183 may be placed atop the instrument deck 182. The removable tray 183 may include handles 184 for easy carrying.

The removable tray 183 may include multiple microplate or labware positions for holding, for example, one or more microplates 185. One or more tip caddies 186 to be processed may be atop certain microplates 185. A tip caddy 186 is a consumable tray or box for holding/packing an arrangement of multiple pipette tips 150. The multi-channel liquid handling instrument 100 may include pipetting head 110 positioned above the instrument deck 182 for aspirating liquids from and/or dispensing liquids. The pipetting head 110 may be equipped with an arrangement of multiple pipette tips 150.

The multi-channel liquid handling instrument 100 may also include robotics instrumentation 188 and controller 190. Robotics instrumentation 188 may be any robotics instrumentation capable of controlling precisely the movement of the pipetting head 110 with respect to the instrument deck 182. The controller 190 may be any standard controller or microprocessor device that is capable of executing program instructions.

Features of the presently disclosed multi-channel liquid handling instrument 100 may include, but are not limited to, removable deck/tray, fully automatic deck/tray calibration, fully-automatic probe for calibrating multiple plate locations, multiple microplate positions, tip caddy position, camera for scanning deck/tray ID and checking tips availability on the caddy, head collision detection, and the like.

In the presently disclosed multi-channel liquid handling instrument 100, the removable tray 183 may be provided with a unique ID number using, for example, a 2D barcode that may be scanned/read using a camera (not shown) on the pipetting head 110. In another example, the removable tray 183 may have a unique radio-frequency identification (RFID) tag that may be scanned/read using an RFID reader (not shown) on the pipetting head 110. In operation, each time the multi-channel liquid handling instrument 100 is used, a user places a removable tray 183 with a certain set of microplates 185 on the instrument deck 182 and then runs a certain protocol. Upon completion, the user then removes his/her removable tray 183. Then, the next user places a next removable tray 183 with a next set of microplates 185 on the instrument deck 182 and then runs a different protocol.

Accordingly, a benefit of the presently disclosed multi-channel liquid handling instrument 100 is that the presence of removable trays 183 allows the instrument to be easily and rapidly shared among multiple users, wherein each user may have his/her own tray with a certain set of microplates 185 and a certain protocol to run. With this shared instrument approach, maximum up/running time of the multi-channel liquid handling instrument 100 may be achieved. This is in comparison with conventional instruments wherein an entire set of microplates must be switched out from the non-removable deck from one user to the next, a slow and cumbersome process that contributes to downtime.

The multi-channel liquid handling instrument 100 and/or pipetting head 110 features positive displacement pipette tips. Each of the positive displacement pipette tips may include a pipette tip and a pipette plunger designed to aspirate and/or dispense a precise volume of liquid. For example, each of the positive displacement pipette tips includes a minimal sized void between the pipette tip and the pipette plunger, thereby optimizing the precision of the liquid volume being aspirated and/or dispensed. Further, the pipetting head 110 provides zero-insertion force clamping mechanisms for both the pipette tip and the pipette plunger of each of the positive displacement pipette tips.

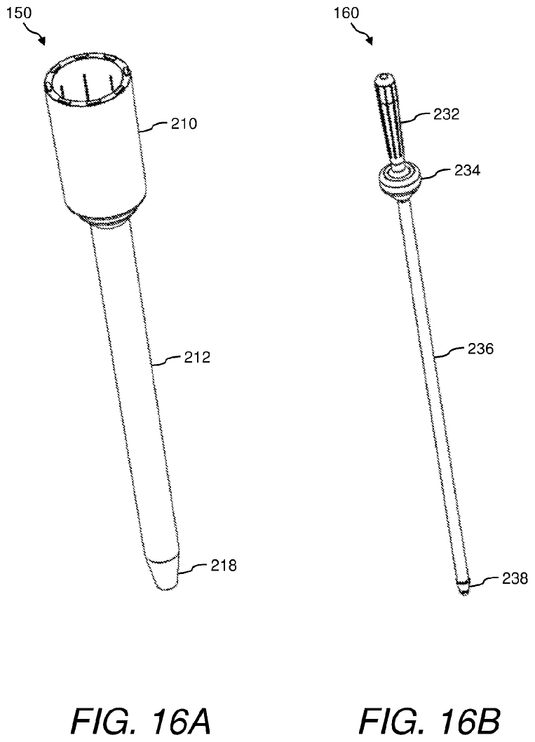

The pipetting head 110 is a multi-channel pipetting head, such as an 8-channel or a 96-channel pipetting head, integrated with a multi-position stage for manipulating one or multiple positive displacement pipette tips 150. For example, the pipetting head 110 may handle 1 tip only, 1-8 tips (in a column), 1-12 tips (in a row), 96 tips, and/or more than one cluster/group tips configuration. More details of an example of a positive displacement pipette tip 150 are shown and described hereinbelow with reference to FIG. 16A through FIG. 20.

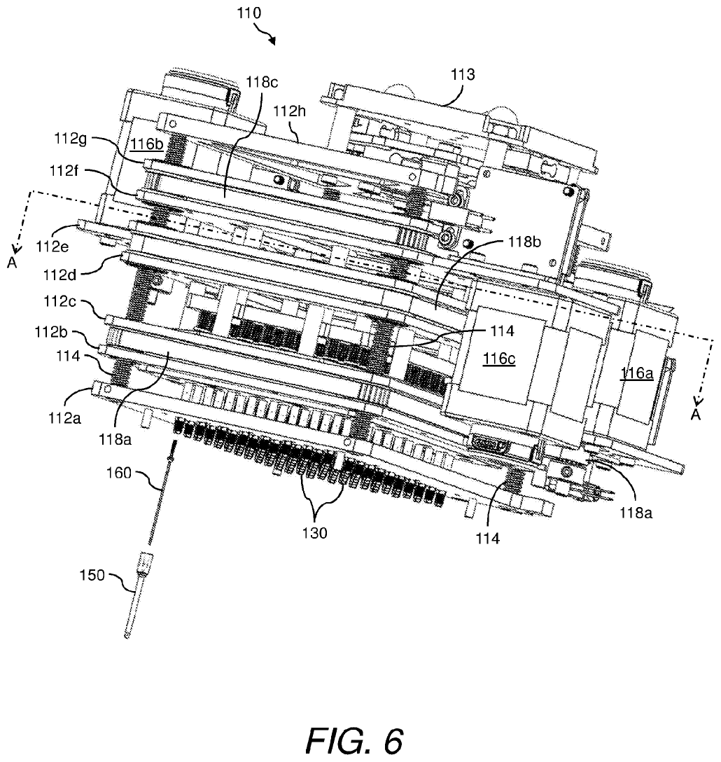

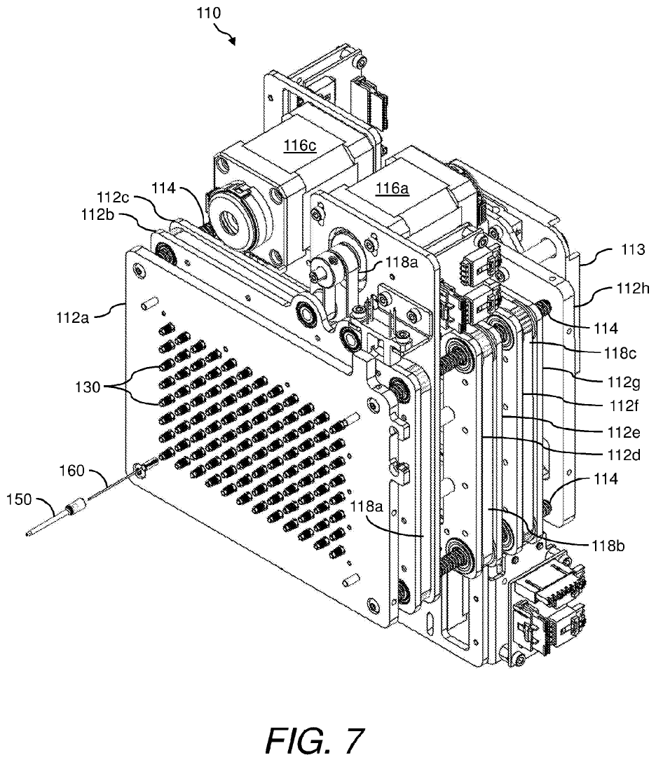

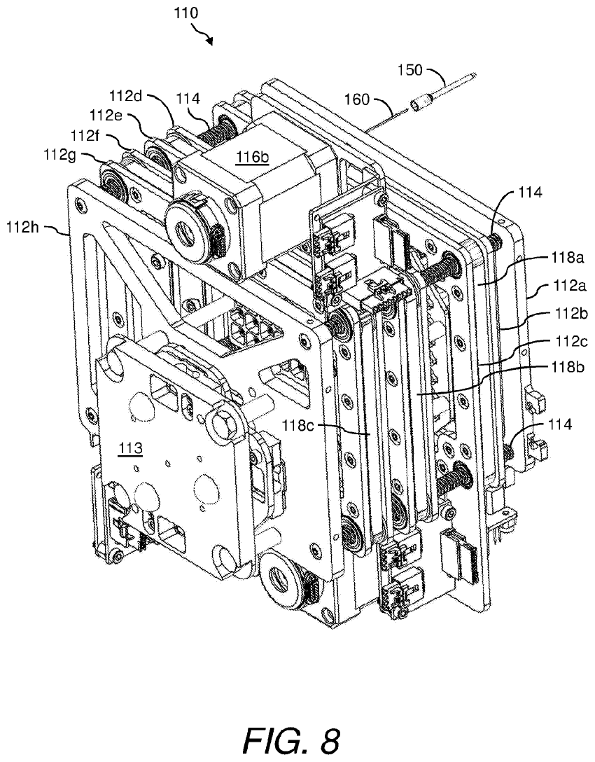

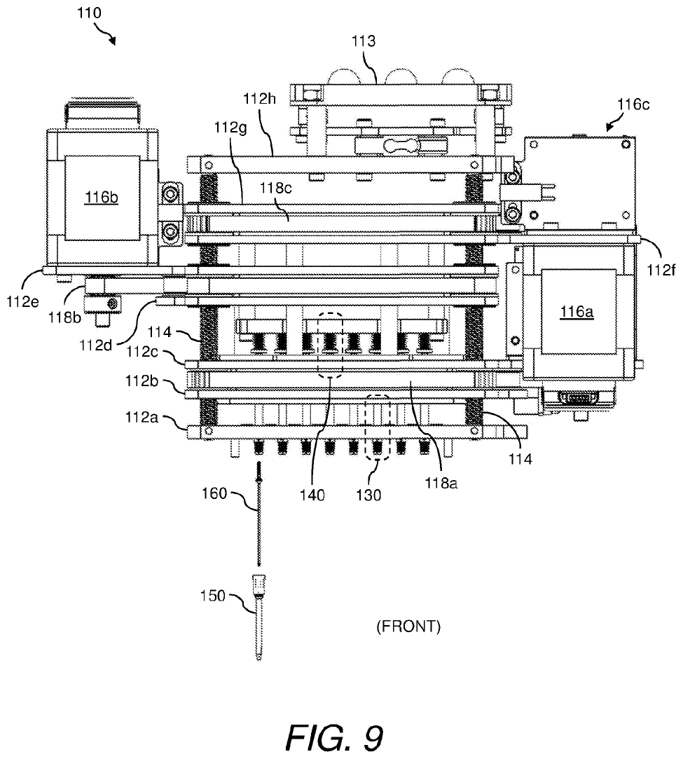

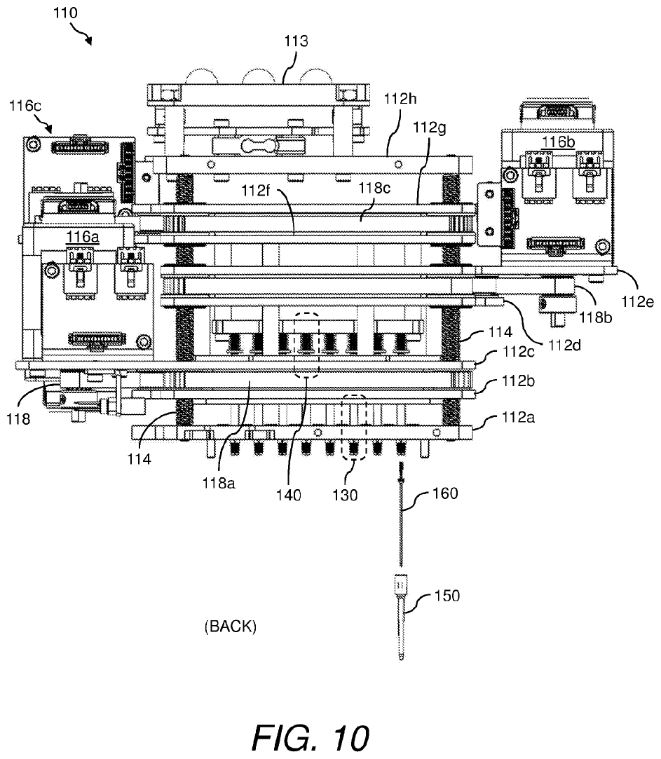

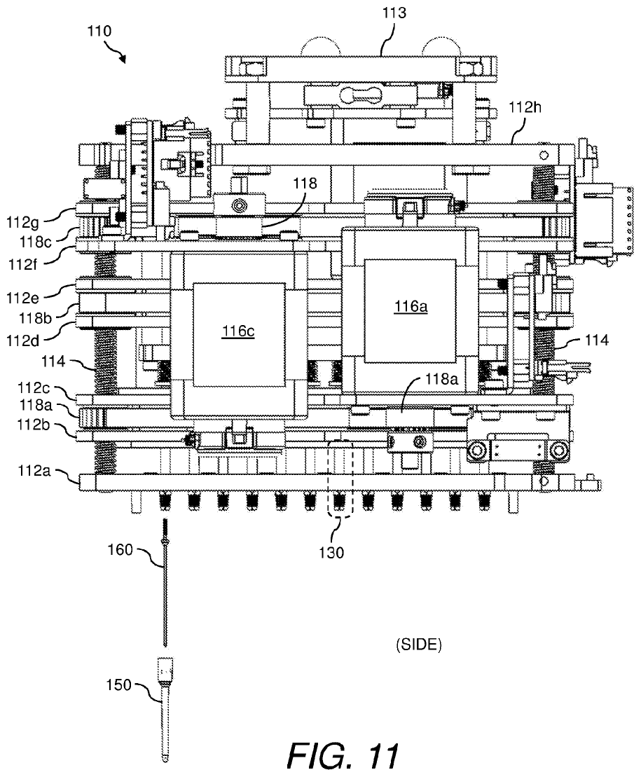

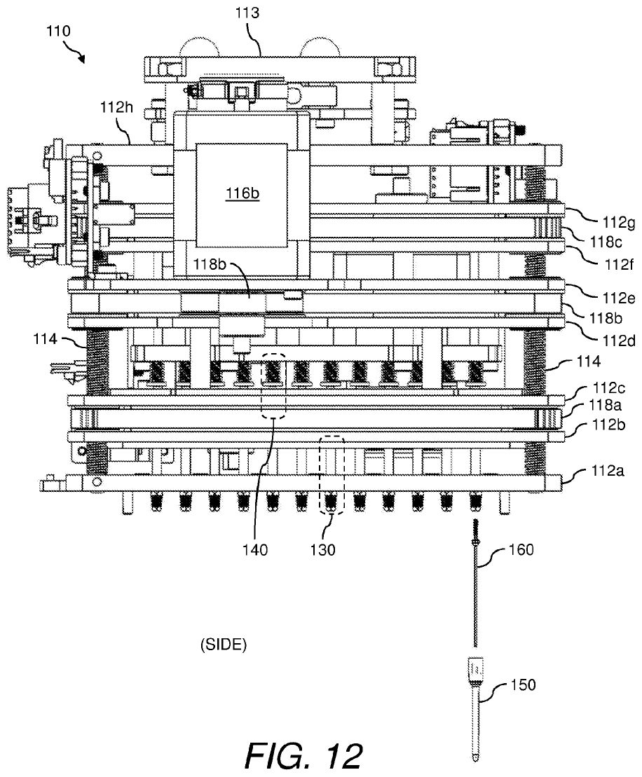

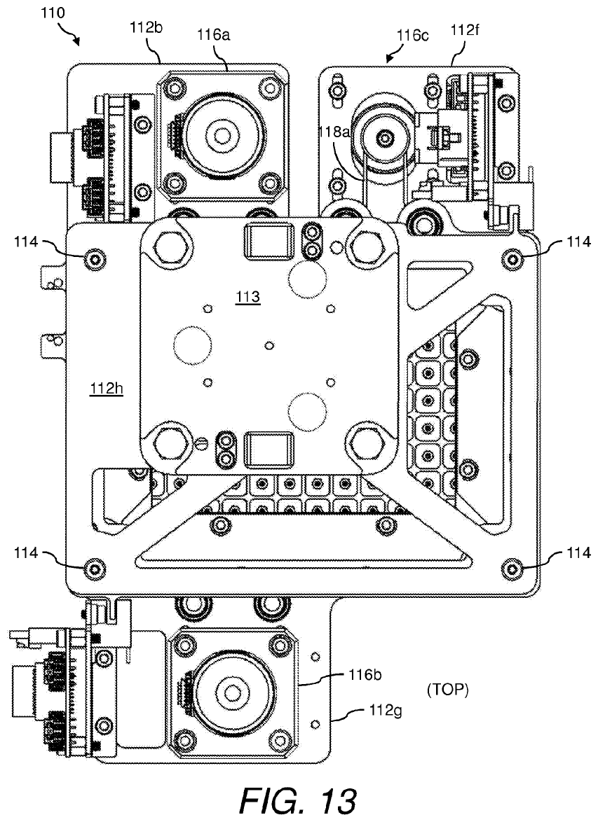

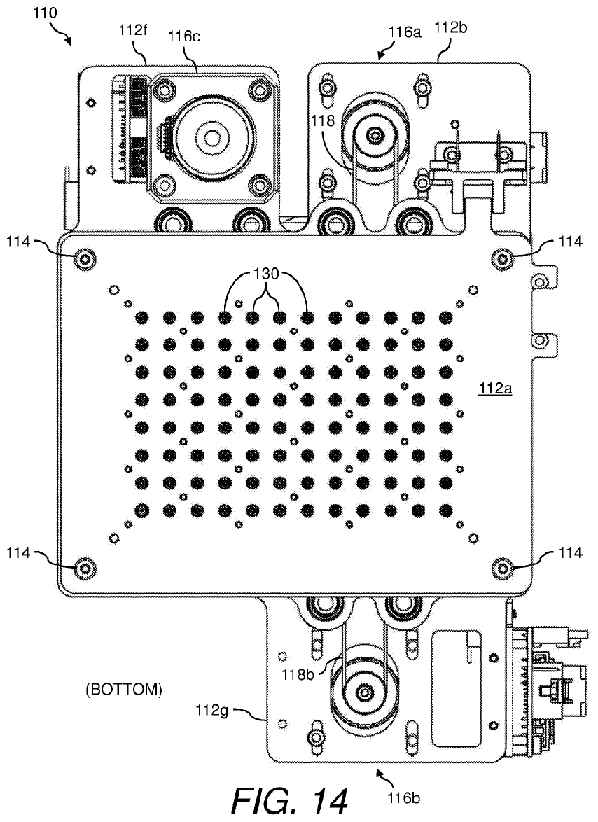

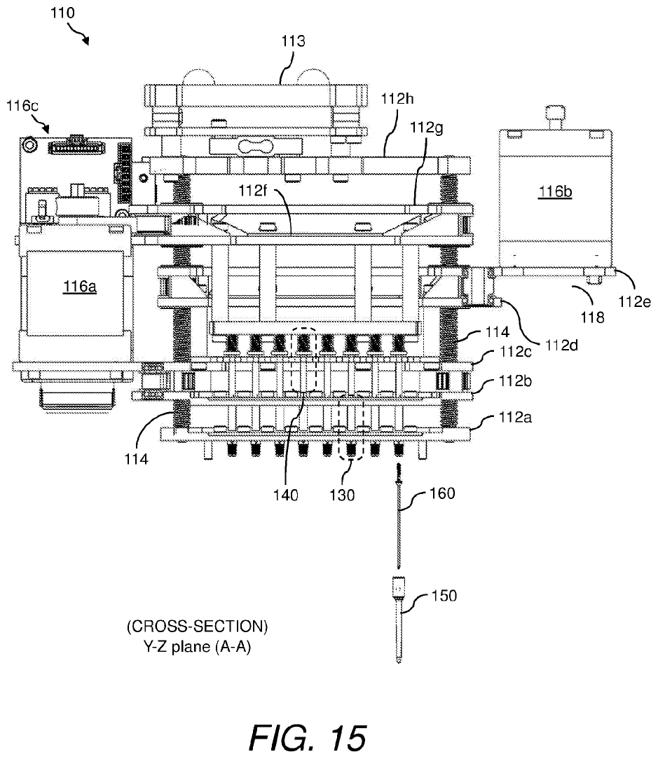

Referring now to FIG. 6 through FIG. 15, FIG. 6, FIG. 7, and FIG. 8 are various perspective views of an example of the pipetting head 110 including an arrangement of positive displacement pipette tips 150 for aspirating and/or dispensing liquids. Further, FIG. 9, FIG. 10, FIG. 11, FIG. 12, FIG. 13, and FIG. 14 show a front view, a back view, a side view, another side view, a top view, and a bottom view, respectively, of the pipetting head 110. Further, FIG. 15 shows a cross-sectional view of the pipetting head 110 taken along line A-A of FIG. 6.

Referring still to FIG. 6 through FIG. 15, the pipetting head 110 may include, for example, multiple plates 112 arranged in a stack with respect to four threaded rods (or lead screws) 114, three motors 116 (e.g., 116a, 116b, 116c) that drive three respective timing (or drive) belts 118 (e.g., 118a, 118b, 118c), and a top heat mounting plate 113, in combination with various other support members and/or components. For example, the pipetting head 110 may include, but is not limited to, any types of light sources (e.g., LEDs), cameras, heaters, printed circuit board (PCBs), thermal management devices (e.g., fans, heatsinks), any types of sensors, any types of actuators, and the like. Additionally, the pipetting head 110 may include a wide variety of components, such as, but not limited to, handles, plates, panels, bars, rods, shafts, brackets, blocks, spacers, hubs, collars, clamps, bushings, bearings, pins, dowels, cams, aligners, screws, nuts, bolts, washers, springs, clips, any types of mechanical connectors, any types of electrical connectors, and the like.

The four threaded rods 114 may be arranged in a substantially rectangular configuration that correlates to the four corners of the substantially rectangular plates 112. In one example, the pipetting head 110 includes eight plates 112 (112a, 112b, 112c, 112d, 112e, 112f, 112g, 112h). Further, the eight plates 112a, 112b, 112c, 112d, 112e, 112f, 112g, 112h may be arranged in order from bottom to top along the four threaded rods 114. For example, plate 112a (hereafter called the bottom plate 112a) is held fixed at the bottom end of the four threaded rods 114, while plate 112h (hereafter called the top plate 112h) is held fixed at the top end of the four threaded rods 114. The bottom plate 112a may serve as a pipette tip collet holder plate where the positive displacement pipette tips 150 are mounted.

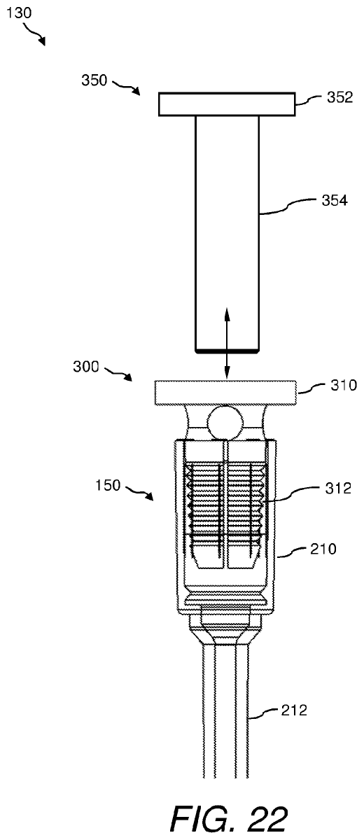

The remaining plates 112b, 112c, 112d, 112e, 112f, 112g may be arranged in pairs and then motor driven up or down along the four threaded rods 114 to perform certain functions. In one example, the motor 116a (hereafter called the clamping tip motor 116a) may be used for precisely controlling a set of zero-insertion force pipette tip clamping mechanisms 130 (see FIG. 22) of the pipetting head 110. The clamping tip motor 116a is supported by plates 112b and 112c. The clamping tip motor 116a drives the timing (or drive) belt 118a (hereafter called the clamping tip timing belt 118a). For example, a threaded timing belt pulley/nut (not shown) is mounted on each of the four threaded rods 114. Accordingly, the clamping tip timing belt 118a is arranged on the four timing belt pulleys and the motor dive pulley (not shown). When the clamping tip motor 116a is activated, the plates 112b and 112c (along with any components mounted thereon) ride together up or down the four threaded rods 114 due to the rotating action of the threaded timing belt pulleys/nuts. That is, the plates 112b and 112c move together away from or toward the bottom plate 112a where the positive displacement pipette tips 150 are mounted.

In another example, the motor 116b (hereafter called the clamping plunger motor 116b) may be used for precisely controlling the zero-insertion force pipette plunger clamping mechanisms 140 of the pipetting head 110. The clamping plunger motor 116b is supported by plates 112d and 112e. The clamping plunger motor 116b drives the timing (or drive) belt 118b (hereafter called the clamping plunger timing belt 118b). For example, a threaded timing belt pulley/nut (not shown) is mounted on each of the four threaded rods 114. Accordingly, the clamping plunger timing belt 118b is arranged on the four timing belt pulleys and the motor dive pulley (not shown). When the clamping plunger motor 116b is activated, the plates 112d and 112e (along with any components mounted thereon) ride together up or down the four threaded rods 114 due to the rotating action of the threaded timing belt pulleys/nuts. That is, the plates 112d and 112e move together away from or toward the bottom plate 112a where the positive displacement pipette plungers 150 are mounted.

In yet another example, the motor 116c (hereafter called the metering plunger motor 116c) may be used for controlling the pipette plunger of the pipetting head 110 for precisely aspirating and/or dispensing liquids. The metering plunger motor 116c is supported by plates 112f and 112g. The metering plunger motor 116c drives the timing (or drive) belt 118c (hereafter called the metering plunger timing belt 118c). For example, a threaded timing belt pulley/nut (not shown) is mounted on each of the four threaded rods 114. Accordingly, the metering plunger timing belt 118c is arranged on the four timing belt pulleys and the motor dive pulley (not shown). When the metering plunger motor 116c is activated, the plates 112f and 112g (along with any components mounted thereon) ride together up or down the four threaded rods 114 due to the rotating action of the threaded timing belt pulleys/nuts. That is, the plates 112f and 112g move together away from or toward the bottom plate 112a where the positive displacement pipette plungers 150 are mounted.

In all cases, the threaded timing belt pulleys/nuts (not shown) are custom components that have a dual function. In a first function, the threaded timing belt pulleys/nuts act as pulleys with respect to the operation of the timing (or drive) belts 118. In a second function, the threaded timing belt pulleys/nuts act as nuts with respect to the threaded rods 114. Accordingly, as the timing (or drive) belts 118 rotate the threaded timing belt pulleys/nuts, the threaded timing belt pulleys/nuts ride up or down the threaded rods 114 depending on the direction of rotation.

Further, one or more pipette tip clamping mechanisms 130 (see FIG. 22) are provided in relation to the bottom plate 112a, which is at the lower portion of the pipetting head 110. Namely, one pipette tip clamping mechanism 130 is provided in relation to each of the positive displacement pipette tips 150. For example, in an 8-channel liquid handling instrument 100, 8 pipette tip clamping mechanisms 130 are provided. In another example, in a 96-channel liquid handling instrument 100, 96 pipette tip clamping mechanisms 130 are provided. Each of the pipette tip clamping mechanisms 130 is used to couple to (or grip) an interface portion 210 (see FIG. 22) of its respective positive displacement pipette tip 150 so that the pipetting head 110 can capture and/or release the positive displacement pipette tip 150. Additionally, each of the pipette tip clamping mechanisms 130 is a zero-insertion force mechanism. More details of an example of a pipette tip clamping mechanism 130 are shown and described hereinbelow with reference to FIG. 22.

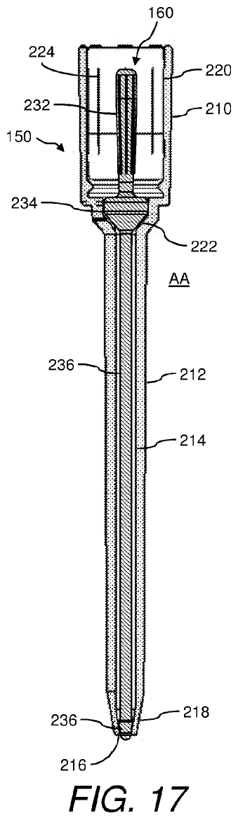

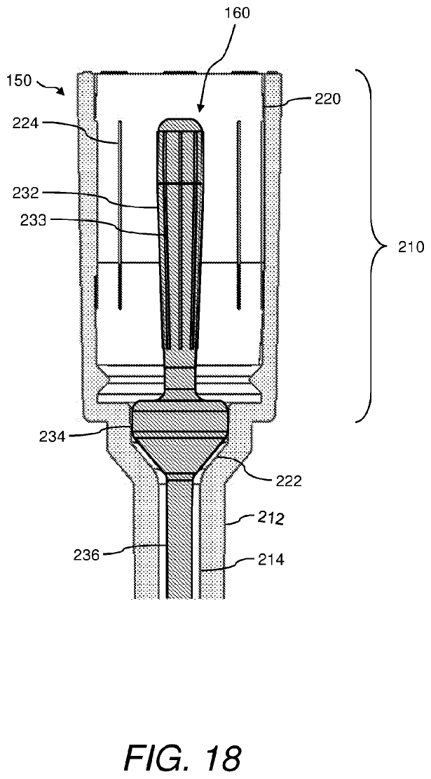

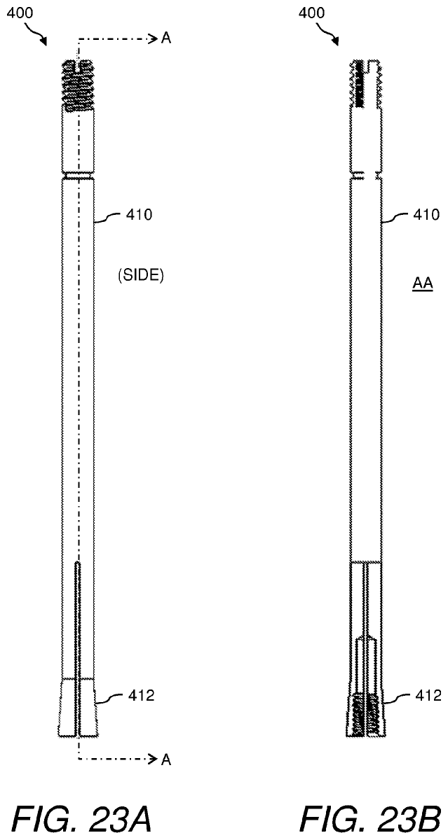

Further, one or more pipette plunger clamping mechanisms 140 (see FIG. 23A through FIG. 25B) are provided in a central portion of the pipetting head 110. Namely, one pipette plunger clamping mechanism 140 is provided in relation to each of the positive displacement pipette tips 150. For example, in an 8-channel liquid handling instrument 100, 8 pipette plunger clamping mechanisms 140 are provided. In another example, in a 96-channel liquid handling instrument 100, 96 pipette plunger clamping mechanisms 140 are provided. Each of the pipette plunger clamping mechanisms 140 is used to couple to (or grip) a plunger 160 (see FIG. 16B, FIG. 17, and FIG. 18) of its respective positive displacement pipette tip 150 so that the pipetting head 110 can actuate the plunger 160 for aspirating and/or dispensing liquid. Additionally, each of the pipette plunger clamping mechanisms 140 is a zero-insertion force mechanism.

Referring still to FIG. 6 through FIG. 15, the pipetting head 110 of the presently disclosed multi-channel liquid handling instrument 100 is used to drive the pipette tip clamping mechanisms 130, the pipette plunger clamping mechanisms 140, and the metering operations (e.g., aspirate/dispense operations) of the positive displacement pipette tips 150. Further, the presently disclosed multi-channel liquid handling instrument 100 features (1) zero-insertion force pipette tip clamping mechanisms 130, and (2) zero-insertion force pipette plunger clamping mechanisms 140.

Referring now to FIG. 16A, FIG. 16B, FIG. 17, and FIG. 18 are various views of an example of the presently disclosed positive displacement pipette tip 150 and pipette plunger 160 for aspirating and/or dispensing liquids in a liquid handling instrument and/or system. For example, FIG. 16A shows a perspective view of an example of the positive displacement pipette tip 150. FIG. 16B shows a perspective view of an example of the pipette plunger 160. Further, FIG. 17 shows a cross-sectional view of the positive displacement pipette tip 150 and with the pipette plunger 160 positioned with respect to the positive displacement pipette tip 150.

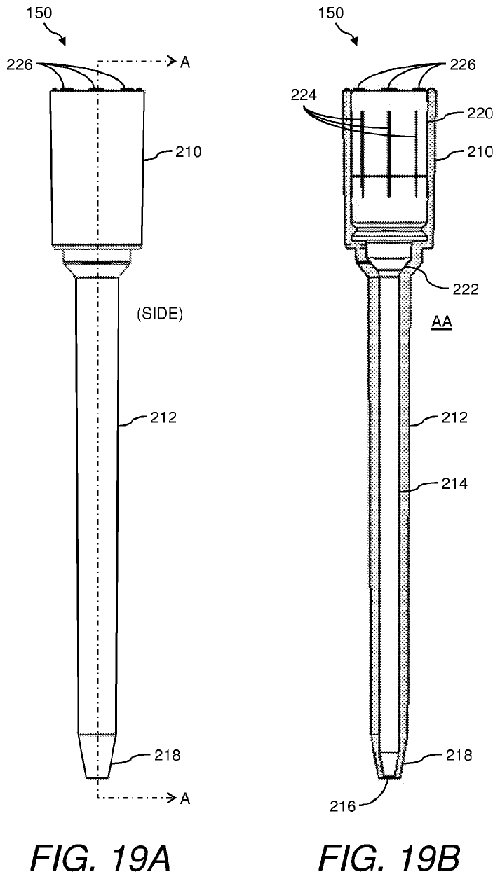

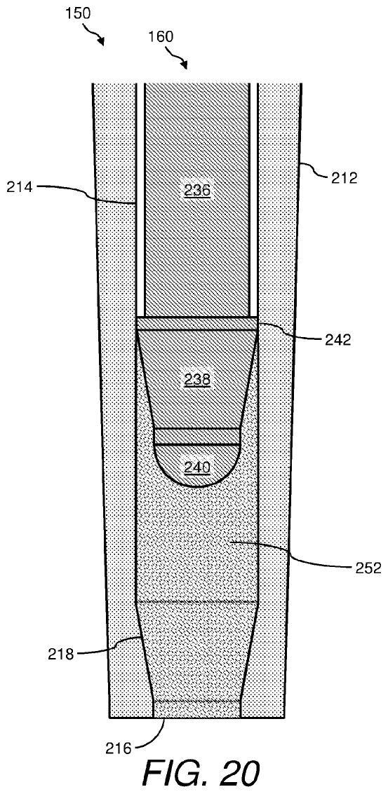

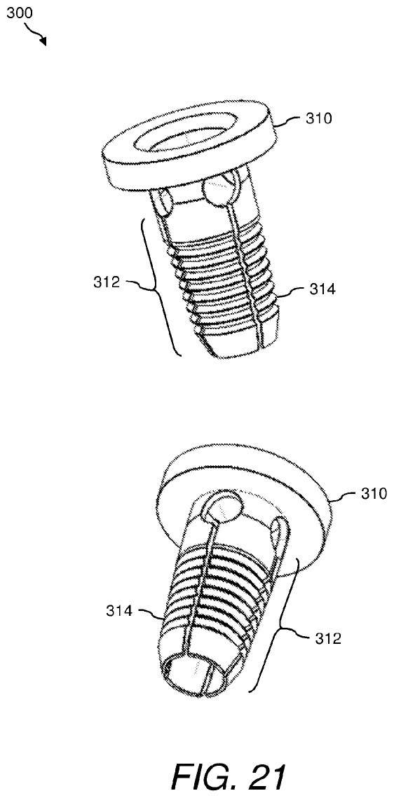

The positive displacement pipette tip 150 includes an interface portion 210 and a pipette tip body 212. The interface portion 210 may be, for example, an open barrel type of structure leading to the pipette tip body 212. Accordingly, the interface portion 210 has an inner wall 220. The interface portion 210 of the positive displacement pipette tip 150 may be fitted to, for example, a mating component (see FIG. 21 and FIG. 22) of the pipetting head 110. A fluid channel 214 runs along the length of the pipette tip body 212. There is an opening 216 (see FIG. 20) at the distal end of the fluid channel 214 through which fluid may be aspirated and/or dispensed. Additionally, the distal end of the pipette tip body 212 that leads to the opening 216 has a tapered tip 218 (see FIG. 20). Further, a receptacle (or cavity) 222 is provided at the lower portion of the interface portion 210 of the positive displacement pipette tip 150. The positive displacement pipette tip 150 may be formed, for example, of polymer. More details of an example of the positive displacement pipette tip 150 are shown and described hereinbelow with reference to FIG. 19A and FIG. 19B.

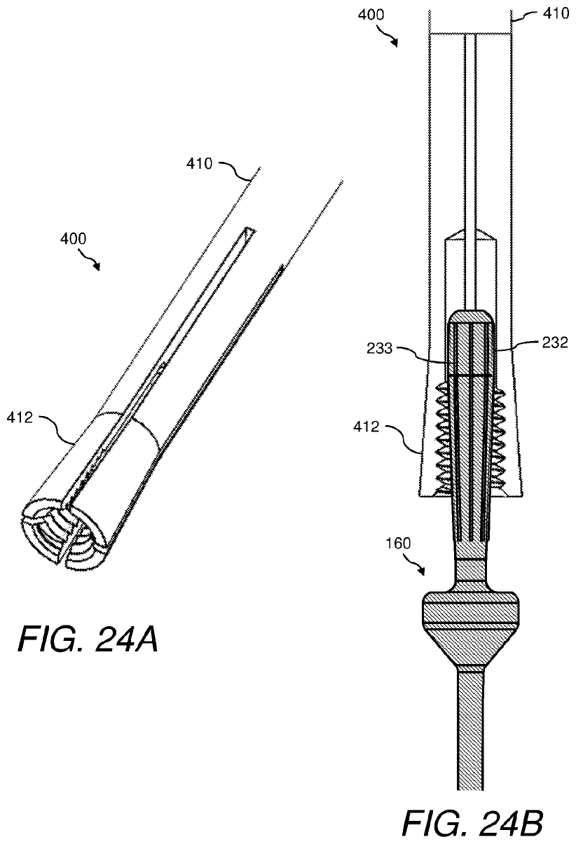

The pipette plunger 160 is arranged along the inside of the positive displacement pipette tip 150. The pipette plunger 160 includes a plunger upper portion 232, a plunger centering portion 234, and a plunger tip 236 that includes a distal tip portion 238. The plunger upper portion 232 may be fitted to, for example, a mating component (see FIG. 23A through FIG. 24B) of the pipetting head 110. Further, the plunger centering portion 234 may be fitted into the plunger stop receptacle (or cavity) 222 of the interface portion 210 of the positive displacement pipette tip 150, wherein the plunger stop receptacle (or cavity) 222 is designed to receive the plunger centering portion 234 of the pipette plunger 160. The plunger centering portion 234 acts as a “stopping” feature of the pipette plunger 160. The plunger tip 236 and distal tip portion 238 of the pipette plunger 160 may be fitted into the fluid channel 214 of the pipette tip body 212 of the positive displacement pipette tip 150. Further, the distal tip portion 238 of the plunger tip 236 is designed to mate and seal with the opening 216 and the tapered tip 218 at the distal end of the fluid channel 214 of the positive displacement pipette tip 150.

Further, FIG. 18 shows a cross-sectional view of the upper portion of the presently disclosed positive displacement pipette tip 150 shown in FIG. 17. For example, FIG. 18 shows a cross-sectional view of the upper portion of the positive displacement pipette tip 150 and the pipette plunger 160 of the positive displacement pipette tip 150. In this view, other features of the positive displacement pipette tip 150 and the pipette plunger 160 are depicted. For example, the positive displacement pipette tip 150 further includes a set of vertical inner wall features 224 along the inner wall 220 of the interface portion 210. In one example, the positive displacement pipette tip 150 includes eight vertical inner wall features 224. Each of the vertical inner wall features 224 is a raised or protruding vertical line feature that is formed along the inner wall 220 of the interface portion 210.

The set of vertical inner wall features 224 is provided to assist clamping or mating the interface portion 210 of the positive displacement pipette tip 150 to a mating component (see FIG. 21 and FIG. 22) of a liquid handling instrument (not shown). For example, the set of vertical inner wall features 224 may assist by increasing the friction force for holding the positive displacement pipette tip 150 in place while potentially reducing the given force needed to hold the positive displacement pipette tip 150 in place.

Referring still to FIG. 18, the pipette plunger 160 further includes a set of vertical outer wall features 233 along the outer wall of the plunger upper portion 232. In one example, the pipette plunger 160 includes eight vertical outer wall features 233. Each of the vertical outer wall features 233 is a raised or protruding vertical line feature that is formed along the outer wall of the plunger upper portion 232.

The set of vertical outer wall features 233 is provided to assist clamping or mating the plunger upper portion 232 of the pipette plunger 160 to a mating component (see FIG. 23A through FIG. 25B) of a liquid handling instrument (not shown). For example, the set of vertical outer wall features 233 may assist by increasing the friction force for holding the pipette plunger 160 in place while potentially reducing the given force needed to hold the pipette plunger 160 in place.

Referring now to FIG. 19A and FIG. 19B are a side view and a cross-sectional view, respectively, of the positive displacement pipette tip 150 of the presently disclosed positive displacement pipette tip 150. For example, FIG. 19B is a cross-sectional view taken along line A-A of FIG. 19A.

Referring now to FIG. 20 is cross-sectional view of the distal tip portion 238 of the pipette plunger 160 with respect to the distal tip portion of the pipette tip body 212 of the positive displacement pipette tip 150. A rounded portion 240 of the distal tip portion 238 of the pipette plunger 160 may be designed to mate with the opening 216 and the tapered tip 218 at the distal end of the fluid channel 214 of the positive displacement pipette tip 150. For example, the distal tip portion 238 has tapered sidewalls that correspond to the tapered tip 218 of the fluid channel 214. Further, an outer upper edge 242 of the distal tip portion 238 of the plunger tip 236 is sized to slidably seal against and along the walls of the fluid channel 214 of the pipette tip body 212. The outer upper edge 242 of the distal tip portion 238 of the plunger tip 236 provides a “sealing” ring feature of the pipette plunger 160 that may hold reliable for many mixing cycles before eventually wearing down and leaking.

When the distal tip portion 238 and the rounded portion 240 of the pipette plunger 160 are sealed against with the opening 216 and the tapered tip 218 at the distal end of the fluid channel 214 of the positive displacement pipette tip 150, a very small void only may be present between the tapered tip 218 of the fluid channel 214 and the tapered sidewalls of the distal tip portion 238 of the pipette plunger 160. In one example, aspirating fluid 252 can be trapped within this small void. A beneficial feature of the positive displacement pipette tip 150 is that the design of the distal tip portion 238 of the pipette plunger 160 minimizes the size of this void. As a result, the liquid volume being aspirated and/or dispensed can be precisely held. Further, the positive displacement pipette tip 150 can be used with substantially any liquid class range.

FIG. 20 shows an example of the positive displacement pipette tip 150 when in use. In one example, FIG. 20 shows the pipette plunger 160 being withdrawn and the aspirating fluid 252 being drawn into the fluid channel 214 of the pipette tip body 212 of the positive displacement pipette tip 150. In another example, FIG. 20 shows the pipette plunger 160 being pushed and the dispensing fluid 252 being pushed out of the fluid channel 214 of the pipette tip body 212 of the positive displacement pipette tip 150.

In standard air displacement pipette tips, things such as temperature, atmospheric pressure, specific gravity, and viscosity of the solution may affect the performance of air displacement pipettes. By contrast, positive displacement pipettes may be used to accurately pipette very viscous, volatile, hot or cold, or corrosive samples. The presently disclosed positive displacement pipette tip 150 and the pipette plunger 160 is an example of a positive displacement pipette.

Referring now to FIG. 21 is a perspective view of an example of the pipette tip collet 300 for use with the positive displacement pipette tip 150 of the presently disclosed positive displacement pipette tip 150. The pipette tip collet 300 may include, for example, an upper ring plate 310 and a collet chuck portion 312 for fitting inside the interface portion 210 of the positive displacement pipette tip 150. Further, the collet chuck portion 312 of the pipette tip collet 300 has a serrated feature 314 to increase the friction to the interface portion 210 of the positive displacement pipette tip 150, as shown, for example, in FIG. 22.

Referring now to FIG. 22, the pipette tip collet 300 is a feature component of the pipette tip clamping mechanism 130. Further, FIG. 22 shows a transparent view of the positive displacement pipette tip 150 with respect to the pipette tip collet 300 shown in FIG. 21. Generally, a “collet” is a segmented band or sleeve that can be expanded and/or contracted. The collet chuck portion 312 of the pipette tip collet 300 is designed to clamp onto any member surrounding the chuck. For example, the collet chuck portion 312 of the pipette tip collet 300 is a segmented band or sleeve for fitting inside the interface portion 210 of the positive displacement pipette tip 150. The collet chuck portion 312 of the pipette tip collet 300 is designed to expand and lock against the inner wall 220 of the interface portion 210 of the positive displacement pipette tip 150. That is, when in the locked position, the collet chuck portion 312 (or clamping chuck) clamps onto the interface portion 210 of the positive displacement pipette tip 150 that is surrounding the collet chuck portion 312. Further, the set of vertical inner wall features 224 of the interface portion 210 of the positive displacement pipette tip 150 and/or the serrated feature 314 of the pipette tip collet 300 may be used to assist clamping or mating the interface portion 210 of the positive displacement pipette tip 150 to the collet chuck portion 312 of the pipette tip collet 300.

The pipette tip clamping mechanism 130 is a zero-insertion force pipette tip clamping mechanism The pipette tip clamping mechanism 130 includes the pipette tip collet 300 and a pipette tip lock mechanism 350. The pipette tip lock mechanism 350 may include, for example, an upper ring plate 352 and a hollow sleeve portion 354 for fitting inside the collet chuck portion 312 of the pipette tip collet 300. For example, when the hollow sleeve portion 354 is fitted inside the collet chuck portion 312 of the pipette tip collet 300, the collet chuck portion 312 expands against the inside wall 220 of the interface portion 210 of the positive displacement pipette tip 150. By contrast, when the hollow sleeve portion 354 is withdrawn from the collet chuck portion 312 of the pipette tip collet 300, the collet chuck portion 312 retracts and becomes loose with respect to the interface portion 210 of the positive displacement pipette tip 150.

With respect to utilizing multiple pipette tip clamping mechanisms 130 in the pipetting head 110, the pipetting head 110 may include certain floating mechanisms (not shown) with or without springs to avoid over-constrain issues with respect to operating multiple pipette tip clamping mechanisms 130. Further, the pipetting head 110 may include certain self-centering mechanisms with respect to each of the pipette tip clamping mechanisms 130 for long lifetime and easy assembly.

Referring now to FIG. 23A and FIG. 23B, FIG. 23A is a side view of the plunger collet 400 while FIG. 23B is a cross-sectional view of the plunger collet 400 taken along line A-A of FIG. 23A. The plunger collet 400 is for use with the pipette plunger 160 of the presently disclosed positive displacement pipette tip 150. The plunger collet 400 may include, for example, a shaft portion 410 and a collet chuck portion 412 for fitting around the plunger upper portion 232 of the pipette plunger 160. Further, FIG. 24A shows a perspective view of the collet chuck portion 412 of the pipette plunger 160 and FIG. 24B is a cross-sectional view of the pipette plunger 160 with respect to the collet chuck portion 412 of the plunger collet 400.

The collet chuck portion 412 of the plunger collet 400 is designed to clamp around any member inside the chuck. For example, the collet chuck portion 412 of the plunger collet 400 is a segmented band or sleeve for fitting around the plunger upper portion 232 of the pipette plunger 160. The collet chuck portion 412 of the plunger collet 400 is designed to lock against the outside wall of the plunger upper portion 232 of the pipette plunger 160 (see FIG. 24B). That is, when in the locked position, the collet chuck portion 412 (or clamping chuck) clamps onto the plunger upper portion 232 of the pipette plunger 160 that is inside the collet chuck portion 412. Further, the set of vertical outer wall features 233 of the plunger upper portion 232 of the pipette plunger 160 may be used to assist clamping or mating the plunger upper portion 232 to the collet chuck portion 412 of the plunger collet 400.

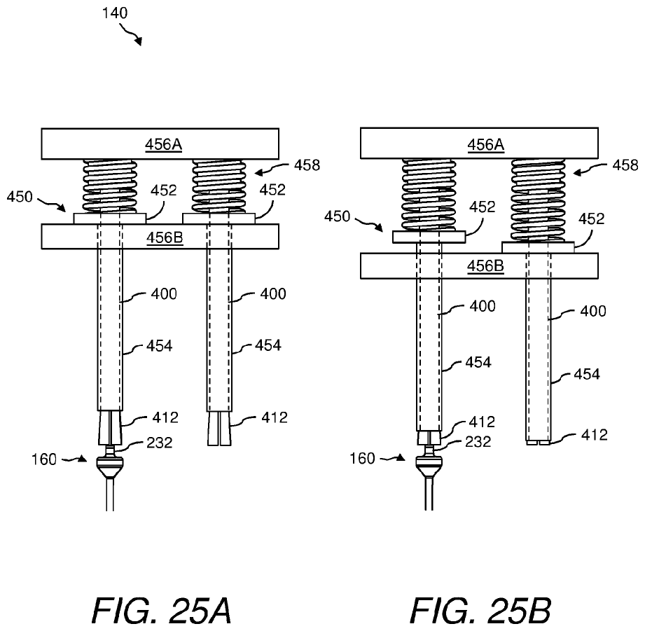

Referring now to FIG. 25A and FIG. 25B, the plunger collet 400 is a feature component of the pipette plunger clamping mechanism 140. Pipette plunger clamping mechanism 140 is a zero-insertion force pipette plunger clamping mechanism. The pipette plunger clamping mechanism 140 includes the plunger collet 400 and a pipette plunger lock mechanism 450. The pipette plunger lock mechanism 450 may include, for example, an upper ring plate 452 and a hollow sleeve portion 454 for fitting around the plunger collet 400 including the collet chuck portion 412. For example, when the hollow sleeve portion 454 is slid down around the collet chuck portion 412 of the plunger collet 400, the collet chuck portion 412 closes against (clamps) the plunger upper portion 232 of the pipette plunger 160. By contrast, when the hollow sleeve portion 454 is withdrawn from the collet chuck portion 412 of the plunger collet 400, the collet chuck portion 412 releases the plunger upper portion 232 of the pipette plunger 160.

FIG. 25A and FIG. 25B show a pair of the pipette plunger clamping mechanisms 140 installed with respect to two plates (456A and 456B) and with two springs 458 between the two plates (456A and 456B). For example, the upper plate 456A is held fixed while each spring 458 provides spring force to a corresponding pipette plunger lock mechanism 450 that passes in slidable (floating) fashion through the lower plate 456B. Further, the upper ends of the plunger collet 400 are fixed to the upper plate 456A. Accordingly, the plunger collets 400 are held fixed with respect to the upper plate 456A while the pipette plunger lock mechanisms 450 and the lower plate 456B are moveable with respect to the upper plate 456A. Accordingly, the pipette plunger lock mechanisms 450 are moveable with respect to the plunger collets 400.

For example, FIG. 25A shows the pipette plunger clamping mechanisms 140 in the non-clamping state. In FIG. 25A, the lower plate 456B is pulled upward toward the upper plate 456A, while compressing the two springs 458. In this state, the hollow sleeve portion 454 of the pipette plunger lock mechanisms 450 is pulled up and away from the collet chuck portion 412 of the plunger collet 400, which allows the plunger collet 400 to open up or expand. In this state, the pipette plunger 160 may be installed into or removed from the plunger collet 400.

By contrast, FIG. 25B shows the pipette plunger clamping mechanisms 140 in the clamping state. In FIG. 25B, the spring force of the two springs 458 pushes the lower plate 456B and the pipette plunger lock mechanisms 450 away from the upper plate 456A. In this state, the hollow sleeve portion 454 pushes down around the collet chuck portion 412 of the plunger collet 400, which causes the plunger collet 400 to close or contract. In this state, the plunger collet 400 is clamped onto the pipette plunger.

The pipette plunger clamping mechanism 140 uses the springs 458 to set the locking preload independently, so that each pipette plunger clamping mechanism 140 can handle independently any varying plunger dimensions from one pipette plunger 160 to the next.

In operation of the presently disclosed positive displacement pipette tip 150 in the pipetting head 110 of the presently disclosed multi-channel liquid handling instrument 100, the positive displacement pipette tip 150 is held fixed while the pipette plunger 160 may be actuated with respect to the positive displacement pipette tip 150 for aspirating and/or dispensing liquids. A benefit of the presently disclosed positive displacement pipette tip 150 is that the positive displacement pipette tip 150 is designed to be manipulated via the pipette tip clamping mechanism 130. In one example, the pipette tip clamping mechanism 130 for the positive displacement pipette tip 150 features a pipette tip collet 300, as shown, for example, in FIG. 21 and FIG. 22. Likewise, the pipette plunger 160 is designed to be manipulated via the pipette plunger clamping mechanism 140. In one example, the pipette plunger clamping mechanism 140 for the positive displacement pipette tip 150 features a plunger collet 400, as shown, for example, in FIG. 23A through FIG. 25B.

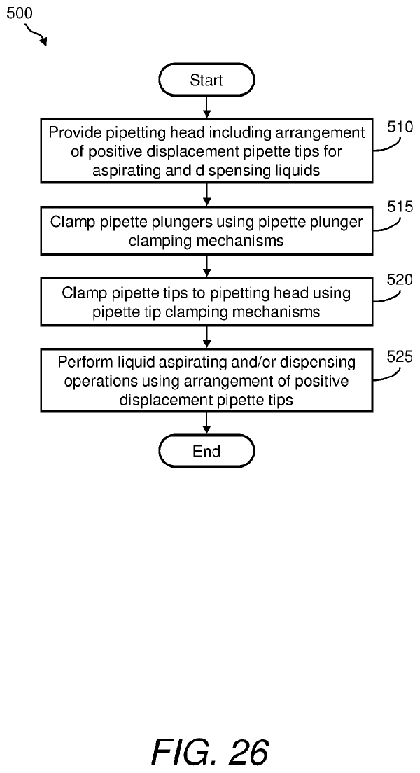

Referring now to FIG. 26 is a flow diagram of an example of a method 500 of using the presently disclosed pipetting head 110 including an arrangement of positive displacement pipette tips 130 for aspirating and/or dispensing liquids. The method 500 may be performed under the control of the multi-channel liquid handling instrument 100 shown in FIG. 1 through FIG. 5. The method 500 may include, but is not limited to, the following steps.

At a step 510, a pipetting head including an arrangement of positive displacement pipette tips for aspirating and dispensing liquids is provided. For example, the pipetting head 110 including an arrangement of positive displacement pipette tips 150 for aspirating and dispensing liquids is provided in, for example, the multi-channel liquid handling instrument 100 shown in FIG. 1 through FIG. 5. The pipetting head 110 is shown, for example, in FIG. 6 through FIG. 15.

At a step 515, the pipette plungers are clamped using the pipette plunger clamping mechanisms. For example, the pipette plungers 160 are clamped using the pipette plunger clamping mechanisms 140 of the pipetting head 110, as shown, for example, in FIG. 25A and FIG. 25B.

At a step 520, the pipette tips are clamped to the pipetting head using the pipette tip clamping mechanisms. For example, the positive displacement pipette tips 150 are clamped using the pipette tip clamping mechanisms 130 of the pipetting head 110, as shown, for example, in FIG. 22.

At a step 525, liquid aspirating and/or dispensing operations are performed using the pipetting head including the arrangement of positive displacement pipette tips. For example, liquid aspirating and/or dispensing operations are performed using the pipetting head 110 including the arrangement of positive displacement pipette tips 150.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A liquid handling instrument, comprising:
an instrument housing with an instrument deck;
a pipetting head above the instrument deck; and
a removable tray, the instrument deck holding the removable tray.

2. The liquid handling instrument of claim 1, wherein the removable tray includes handles.

3. The liquid handling instrument of claim 2, wherein the removable tray holds one or more microplates.

4. The liquid handling instrument of claim 3, further comprising a tip caddy atop one of the one or more microplates.

5. The liquid handling instrument of claim 1, wherein the removable tray has a unique identification number adapted for scanning or reading.

6. The liquid handling instrument of claim 5, wherein the unique identification number is a 2D barcode or a radio-frequency identification tag.

7. The liquid handling instrument of claim 1, further comprising a robotics instrumentation and a controller, the robotics instrumentation adapted to control the movement of the pipetting head with respect to the instrument deck, and the controller adapted to execute program instructions to the liquid handling instrument.

8. The liquid handling instrument of claim 1, further comprising one or multiple positive displacement pipette tips, the pipetting head being a multi-channel pipetting head integrated with a multi-position stage for manipulating the one or more positive displacement pipette tips.

9. The liquid handling instrument of claim 8, wherein the pipetting head comprises:
multiple plates arranged in a stack with respect to four threaded roads;
one or more motors that drive one or more respective timing belts, the one or more motors supported by the multiple plates; and
a top heat mounting plate.

10. The liquid handling instrument of claim 9, wherein the multiple plates are substantially rectangular, the four threaded rods being arranged in substantially rectangular configuration correlating to the four corners of the multiple plates.

11. The liquid handling instrument of claim 9, wherein the multiple plates are eight plates arranged in order from bottom to top along the four threaded rods.

12. The liquid handling instrument of claim 11, wherein the bottom plate of the multiple plates is held fixed at the bottom end of the four threaded rods, the top plate is held fixed at the top of the four threaded rods, the remaining plates being arranged in pairs between the top and bottom plates and are moveable along the four threaded rods.

13. The liquid handling instrument of claim 12, wherein the bottom plate is a pipette tip collet holder plate where the one or more positive displacement pipette tips are mounted.

14. The liquid handling instrument of claim 12, further comprising one or more pipette tip clamping mechanisms.

15. The liquid handling instrument of claim 14, wherein the one or more motors is a clamping tip motor, wherein the one or more timing belts is a clamping tip timing belt, and wherein the clamping tip motor and the clamping tip timing belt are adapted to move one or more of the multiple plates away from or toward the bottom plate.

16. The liquid handling instrument of claim 9, wherein the one or more positive displacement pipette tips comprises:
a pipette tip having an interface portion and a pipette tip body, the interface portion having an inner wall and a receptacle, the pipette tip body having a fluid channel along the length of the pipette tip body, and the fluid channel having an opening at the distal end of the fluid channel; and
a pipette plunger positioned along the inside of the pipette tip, the pipette plunger having a plunger upper portion, a plunger centering portion, and a plunger tip having a distal tip portion, wherein the receptacle is adapted to receive the plunger centering portion, wherein the fluid channel is adapted to receive the distal tip portion of the plunger tip, wherein the one or more pipette tip clamping mechanisms are zero-insertion force pipette clamping mechanisms.

17. The liquid handling instrument of claim 16, wherein the one or more pipette plunger clamping mechanisms are provided in a central portion of the pipetting head, wherein each of the one or more pipette plunger mechanisms couples to a plunger of each of a respective positive displacement pipette tips.

18. The liquid handling instrument of claim 12, further comprising a set of zero-insertion force pipette plunger clamping mechanisms, one of one or more motors used for controlling the set of zero-insertion force pipette plunger mechanisms.

19. The liquid handling instrument of claim 18, wherein the one of the one or more motors is a clamping plunger motor, wherein one of the one or more timing belts is a clamping plunger timing belt, the clamping plunger motor and the clamping plunger timing belt being adapted to move one or more of the multiple plates away from or toward the bottom plate.

20. The liquid handling instrument of claim 12, further comprising a pipette plunger, wherein on of the one or more motors is used for controlling the pipette plunger.

21. The liquid handling instrument of claim 20, wherein one of one or more motors is a metering plunger motor, wherein one of the one or more timing belts is a metering plunger timing belt, the metering plunger motor and the metering plunger timing belt being adapted to move one or more of the multiple plates away from or toward the bottom plate.

22. The liquid handling instrument of claim 12, further comprising one or more pipette plunger clamping mechanisms that are zero-insertion force pipette plunger clamping mechanisms.

23. The liquid handling instrument of claim 22, wherein each of the one or more zero-insertion force pipette plunger clamping mechanisms include a plunger collet and a pipette plunger lock mechanism, the plunger collet including a shaft portion and a collet chuck portion for fitting around the plunger upper portion of the pipette plunger.

24. The liquid handling instrument of claim 23, wherein the collet chuck portion is a segmented band or sleeve for fitting round the plunger upper portion of the pipette plunger.

25. A method for aspirating and/or dispensing liquids, comprising the steps of:
providing a liquid handling instrument, the liquid handling instrument including an instrument housing with an instrument deck, a pipetting head above the instrument deck, and a removable tray, the instrument deck holding the removable tray, the pipetting head having an arrangement of one or more positive displacement pipette tips for aspirating and dispensing liquids, wherein the pipetting head includes one or more pipette tip clamping mechanisms and one or more pipette plunger clamping mechanisms, and wherein each of the one or more positive displacement pipette tips include a pipette tip and a corresponding pipette plunger;
clamping by the one or more pipette plunger clamping mechanisms the one or more pipette plungers;
clamping by the one or more pipette tip clamping mechanisms the one or more pipette tips; and
performing an aspirating and/or dispensing operation using the pipette head.
